(19) United States
(12) Patent Application Publication
(10) Pub. No.: US 2007/0267348 A1
(43) Pub. Date: Nov. 22, 2007

(54) Open Tubular Capillaries Having a Connecting Layer

(75) Inventors: Dieter Lubda, Bensheim (DE); Karin Cabrera, Dreieich (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: MERCK PATENT GmbH, Darmstadt (DE)

(21) Appl. No.: 11/570,299

(22) PCT Filed: May 10, 2005
(86) PCT No.: PCT/EP05/05043

§ 371 Date: Dec. 8, 2006

(30) Foreign Application Priority Data
Jun. 9, 2004 (EP) 04013549.3

(51) Int. Cl. B01D 15/08; B05D 7/22

(52) U.S. Cl. 210/656; 210/198.2; 427/181

(57) ABSTRACT

The invention relates to a method for producing open tubular capillaries containing monolithic sorbents and to said capillaries. The inventive capillaries are characterised by a connection layer between the capillary wall and the sorbent, said layer ensuring a particularly good adhesion of the sorbent to the capillary wall.

The invention relates to a process for the production of open tubular capillaries containing monolithic sorbents, and to the capillaries themselves. The capillaries according to the invention are distinguished by a connecting layer between capillary wall and sorbent which ensures particularly good adhesion of the sorbent to the capillary wall.

Open tubular (OT) capillaries are capillaries which are covered with a sorbent layer only on the inside wall. They are consequently not completely filled with sorbent and thus allow significantly higher flow rates. OT capillaries have already successfully been employed for some time for gas-chromatographic applications (Z. Ji, R. E. Majors, E. J. Guthrie, Journal of Chromatography, 842 (1999), 115-142). The use of OT capillaries for liquid chromatography too has been discussed recently. For example, U.S. Pat. No. 5,869,152 describes the production of OT capillaries which are covered with monolithic hybrid materials as sorbent.

However, it was to date very difficult to produce OT capillaries which are actually suitable for use in liquid chromatography and exhibit sufficiently good properties for commercial utilisation.

Knowledge acquired in the area of liquid chromatography with regard to the properties of suitable sorbents can for the most part not be applied to OT capillaries since particulate materials cannot be employed. Known monolithic support materials, such as, for example, from WO 95/03256 and WO 98/29350, shrink during production and detach from the wall.

WO 99/38006 and WO 99/50654 disclose processes for the production of capillaries which are filled with monolithic silica material. This material can remain directly in the capillary after production since low shrinkage rates are unimportant in the case of filled capillaries of small internal diameter.

In the production of a coating of the inside surface of the capillary, by contrast, even extremely low shrinkage rates have an adverse effect in that cracks in the coating or even individual sorbent lumps form.

In addition, a liquid-chromatographic application makes completely different requirements of a chromatography column than gas chromatography. The major difference naturally consists in that it is not gases, but instead liquids that flow through the column. Liquids have different, i.e. worse diffusion properties than gases and also place greater mechanical stresses on the sorbent, depending on the flow rate. All OT capillaries developed to date therefore exhibit considerable disadvantages on use in liquid chromatography. In particular, the separation properties are deficient and the service times are very short. The principal reason for this is probably that the sorbent coating does not adhere sufficiently strongly to the capillary wall for the above-mentioned reasons and either cracks or forms individual sorbent lumps even during production and/or that the liquid stream attacks and detaches or dissolves parts of the coating during use of the capillaries. If less-porous layers which consequently have a lower shrinkage rate are applied, the mechanical stability of the coating is increased, but layers having worse separation properties are obtained.

The object of the present invention was therefore to provide OT capillaries which are suitable for use in liquid chromatography, in particular HPLC, micro-LC or electrochromatography, i.e. whose sorbent layer can be applied particularly stably and uniformly to the capillary wall.

It has been found that a connecting layer between capillary wall and sorbent produces significantly better adhesion of the sorbent and improves the separation properties and service times of the capillaries. It has furthermore been found that capillaries having particularly good separation properties and service times can be produced if the sorbent layer is applied by means of an epitaxial growth process.

The present invention therefore relates to OT capillaries, characterised in that at least one connecting layer consisting of one of the following materials is located between the inside wall of the capillary and the sorbent:
bifunctional reagents
inorganic polymers
inorganic/organic hybrid materials
organic polymers

This also encompasses the possibility of two or more connecting layers of different materials being present.

In another preferred embodiment, the connecting layer has a thickness of 1 to 5 μm.

In another preferred embodiment, the capillary has an internal diameter of between 20 and 1000 μm.

In another preferred embodiment, the capillary is a fused silica capillary.

In a preferred embodiment, the inside wall of the capillary is completely covered by the connecting layer.

In another preferred embodiment, the connecting layer comprises fibres or particles.

The present invention also relates to a process for the production of open tubular capillaries in which a connecting layer is located between the inside wall of the capillary and the sorbent, characterised by the following process steps:

a) provision of a capillary

b) application of at least one connecting layer consisting of one of the following materials:
bifunctional reagents
inorganic polymers
inorganic/organic hybrid materials
organic polymers

c) application of the sorbent layer.

In a preferred embodiment, the inside wall of the capillary is activated in a step aa) before application of the connecting layer by treatment with strong acids, strong bases or other etchants.

In a preferred embodiment, a sol-gel process is used for the production of the sorbent layer.

In a particularly preferred embodiment, the sorbent layer is applied by pumping in a dilute polymerisation solution, which remains in the capillary until after gelling is complete.

The present invention also relates to OT capillary columns produced by the process according to the invention,

The present invention furthermore relates to the use of the capillary columns according to the invention in liquid chromatography.

Capillaries which are suitable in accordance with the invention have an internal diameter of between 5 and 1500 μm, preferably between 20 and 1000 μm. The thickness of the connecting layer and the sorbent layer is typically matched to the internal diameter of the capillary, i.e. a somewhat smaller connecting and/or sorbent layer is selected in the case of relatively small internal diameters, so that a cavity still remains in the interior of the capillary. The length of the capillaries can vary between 1 cm and 100 metres, depending on the application.

The capillary can consist of metal (for example stainless steel) or plastic (for example PEEK (polyether ether ketone), PTFE (polytetrafluoroethylene) or preferably of materials which are coated with glass on the inside (for example stainless steel with glass inliner), ceramic, glass or other silica materials, such as, for example, fused silica. The person skilled in the art is able to make a selection from these materials on the basis of the planned application, the conditions for activation of the surface of the capillary, the reaction conditions and the reactants employed.

For use in liquid chromatography, the capillaries are provided with connectors for the feed and discharge of eluent. Suitable systems are known to the person skilled in the art.

The core of the present invention is the introduction of a connecting layer between the inside wall of the capillary and the sorbent layer. It has been found that the introduction of a connecting layer greatly reduces the formation of cracks in the sorbent layer. This is preferably carried out by employing a connecting layer which
increases the number of functional groups available for binding of the sorbent layer
and/or increases the inside surface area of the capillary
and/or provides more reactive functional groups for binding of the sorbent layer.

In accordance with the invention, the connecting layer can consist of one of the following materials:
bifunctional reagents
inorganic polymers
inorganic/organic hybrid materials
organic polymers

In accordance with the invention, a plurality of connecting layers comprising identical or different materials can also be applied instead of a single connecting layer. In accordance with the invention, the expression “connecting layer” therefore stands for one or more layers.

A connecting layer typically has a thickness of between 1 μm and 20 μm, preferably between 2 and 5 μm.

The connecting layer preferably covers the entire inside surface of the capillary or reacts as far as possible with all functional groups available on the inside surface. In some cases, however, it may be sufficient for the connecting layer to cover the inside wall of the capillary uniformly, but only partly (at least 50%) or for only some (at least 50%) of the functional groups of the inside wall of the capillary to have reacted. An only partly covered surface or only partly reacted functional groups also count as connecting layer in accordance with the invention.

The individual suitable materials are explained below:

1. Bifunctional Reagents

In this case, the inside surface of the capillary is treated with reagents which have at least two, preferably three or four, functionalities. In accordance with the invention, suitable reagents having at least two functionalities are referred to as bifunctional reagents. It is assumed that the reduction in shrinkage after treatment of the surface with these reagents is due to the fact that at least one functionality reacts with the surface of the gelling mould and at least one functionality is available for reaction with the monomer sol. Dendritic structures are preferably built up on the inside wall of the capillary, increasing the number of functional groups available for binding of the sorbent layer.

Suitable here are, for example, alkoxysilanes or organoalkoxysilanes. Particular preference is given to:
bifunctional silanes of the formula I
   (RO)₁₋₃—Si—(CH₂)n—Si—(OR)₁₋₃ I

where the radicals R, independently of one another, are typically an alkyl, alkenyl or aryl radical, such as C1 to C20 alkyl, C2 to C20 alkenyl or C5 to C20 aryl, preferably a C1 to C8 alkyl radical, and
n=0 to 20, preferably 0 to 8, where one or more non-adjacent methylene groups may be replaced by O, S, NH, NR, CONH (amide), CO, COO, SO or SO₂, preferably by O, S, NH or CONH.

Examples of preferred compounds are BTME (bis(trimethoxysilyl)ethane, where R=methyl and n=2), bis(triethoxysilyl)ethane, bis(triethoxysilyl)methane and bis(triethoxysilyl)octane.
mono-, bi- or trifunctional alkoxysilanes having a fourth terminal function of the formula II
   (RO)ₙR′ₘSi—R* II
   where R and R′ are typically, independently of one another, an alkyl, alkenyl or aryl radical, preferably a C1 to C8 alkyl radical, and R* contains an Si—OH reactive group, such as an amino or epoxide group. This means that R* is, for example, alkylamino, alkenylamino or arylamino, preferably a C1 to C8 alkylamino or glycidoxyalkyl, glycidoxyalkenyl or glycidoxyaryl, preferably C1 to C8 glycidoxyalkyl. m is 0, 1 or 2, n+m is 3. Examples of suitable compounds of the formula II are 3-glycidoxypropyltrimethoxysilane, 3-glycidoxypropylmethyldimethoxysilane or 3-glycidoxypropylmethyldiethoxysilane and 3-aminopropylmethyldiethoxysilane, 3-aminopropyldimethylethoxysilane or preferably 3-aminopropyltriethoxysilane or 3-aminopropyltrimethoxysilane.

The bifunctional reagents are typically employed in the form of a 2 to 25%, preferably 5 to 10% (% by weight), solution in an organic solvent, such as, for example, toluene. The treatment of the capillary is preferably carried out at elevated temperature between 50 and 150° C.; for example, in refluxing toluene. The duration of the treatment is generally between 1 and 40 hours, typically 10 to 25 hours.

The treatment can be carried out by immersion of the entire capillary or rinsing or filling the interior of the capillary. Finally, rinsing is carried out with an organic solvent.

The use of bifunctional reagents can also be combined with the other methods for the introduction of a connecting layer. For example, the inside surface can firstly be provided with a relatively large number of functional groups by reaction with bifunctional reagents with formation of a dendritic structure or a network. In a second step, a connecting layer comprising an organic, inorganic or hybrid material is then applied.

2. Connecting Layer Comprising an Organic Polymer

A connecting layer comprising an organic polymer offers the advantage that organic polymers are usually not quite as rigid as inorganic polymers. It has been found that a connecting layer comprising an organic polymer therefore acts like a buffer layer, which is able to compensate for stresses and thus prevents cracking of the sorbent.

Suitable in accordance with the invention are all organic polymers which are sufficiently stable under the conditions of liquid chromatography. Examples thereof are polystyrenes, polyethylene oxides and polymethacrylates.

Since organic polymers are frequently not able to react directly with the functional groups of the capillary wall, it may be necessary to react the latter in advance with a bifunctional reagent which on the one hand reacts with the capillary wall and on the other hand provides suitable functional groups for polymerising-on the organic polymer. In the case of fused silica capillaries, this can be, for example, a silane which carries at least one non-hydrolysable radical having a reactive double bond, such as, for example, methacryloxypropyltrimethoxysilane.

It may equally be necessary firstly to functionalise the layer of the organic polymer in a suitable manner before application of the sorbent layer. Here too, for example, suitable bifunctional silanes can be employed.

The layer of the organic polymer can be polymerised on by known methods, for example by means of free-radical polymerisation. Equally, particles or fibres, in particular particles of an organic polymer, can be added to the polymerisation solution, or particles of an organic polymer can be applied to the capillary wall as connecting layer in a different manner. However, it is also possible to add inorganic particles or fibres or derivatised inorganic particles or fibres to the polymerisation.

3. Inorganic Polymers/Hybrid Materials

In this case, the capillary is pretreated with a solution or slurry. The solution consists of a monomer sol similar to that later used for the formation of the sorbent layer, i.e. it comprises alkoxysilanes just like the monomer sol. These alkoxysilanes are able to react with the inside surface of the capillary, where they are polymerised to completion and/or are sintered on. In this way, a coating forms on the inside surface of the capillary, which increases the inside surface area through its structure. Suitable alkoxysilanes are tetraalkoxysilanes (RO)₄Si, where R is typically an alkyl, alkenyl or aryl radical, such as C1 to C20 alkyl, C2 to C20 alkenyl or C5 to C20 aryl, preferably a C1 to C8 alkyl radical. Particular preference is given to tetraethoxy- and in particular tetramethoxysilane. The tetraalkoxysilane may equally contain different alkyl radicals. The alkoxysilanes can also be employed in prepolymerised form as, for example, oligomers instead of in their monomeric form.

In another embodiment, organoalkoxysilanes or mixtures of organoalkoxysilanes with tetraalkoxysilanes can be employed instead of an alkoxysilane or mixtures of two or more alkoxysilanes. Suitable organoalkoxysilanes are those in which one to three, preferably one, alkoxy group(s) of a tetraalkoxysilane has (have) been replaced by organic radicals, such as, preferably, C1 to C20 alkyl, C2 to C20 alkenyl or C5 to C20 aryl. Further organoalkoxysilanes are disclosed, for example, in WO 03/014450 and U.S. Pat. No. 4,017,528. The alkoxysilanes and organoalkoxysilanes can also be employed in prepolymerised form as, for example, oligomers instead of in their monomeric form.

The tetraalkoxysilanes and organoalkoxysilanes are typically employed in the form of a 2 to 25%, preferably 5 to 10% (% by weight), solution in an organic solvent, such as, for example, toluene or ethanol. Mixtures of water with a water-miscible solvent are also possible. The treatment of the capillary is preferably carried out at elevated temperature between 30 and 150° C., for example in refluxing toluene. The duration of the treatment is generally between 1 and 40 hours, typically 10 to 25 hours.

Inorganic hybrid material and/or organic particles or fibres can also be added to a connecting layer comprising an inorganic or hybrid polymer during production. Furthermore, the connecting layer may also consist in its entirety of inorganic and/or hybrid material particles, which are, for example, sintered onto the capillary wall.

The stability and action of the connecting layers according to the invention can be supported by the following preferred additional measures:

1. Etching

This process is particularly suitable for capillaries made of ceramic, glass or other silica-based materials. In this case, at least the inside surface of the capillary is etched with strong acids or strong bases or other etching compounds. In this way, for example, activated, reactive silanol groups are formed to an increased extent on the inside surface of the capillary. Furthermore, partial dissolution of the silicate structure of the glass occurs with strong bases, which results in an increase in the surface area.

Suitable strong acids or bases are, for example, HF, HCl, HNO₃ or H₂SO₄, NaOH, KOH, NH₄OH, preferably HF and HCl or NaOH. H₂O₂ in combination with an acid or base is likewise suitable. The duration of the treatment depends on the material of the capillary. In general, the moulds are treated at temperatures between 25° C. and 80° C. for between 5 minutes and 24 hours. The treatment can be carried out by immersion of the entire capillary or rinsing or filling the interior of the capillary. In the case of the use of a base, the final step is rinsing with dilute acid (for neutralisation), with water and finally with an organic solvent, such as, for example, ethanol, or, in the case of the acid, with water and an organic solvent.

2. Addition of Particles and/or Fibres

In another preferred embodiment, the solution for the production of the connecting layer and/or sorbent layer additionally comprises particles and is thus a particle suspension or slurry. The particles typically have a diameter of between 25 nm and 10 μm, preferably between 50 nm and 1 μm, and typically consist of plastic, ceramic, glass or inorganic oxides, such as, for example, Ti, Al, Zr or Si oxides. They preferably have a hydrophilic surface. However, hydrophobic or hydrophobically derivatised particles, for example with C1-C20 alkyl radicals, are also particularly suitable if the solution serves for the preparation of an organic polymer or consists of organoalkoxysilanes and/or mixtures of organoalkoxysilanes with alkoxysilanes.

The particles may be nonporous or porous. Spherical or also irregularly shaped particles are suitable. Particular preference is given to silica particles having a diameter of between 50 nm and 1 μm.

A further possibility for reducing the shrinkage rate is the addition of fibres to the connecting layer and/or sorbent layer. In accordance with the invention, fibres are structures having an elongate shape whose length is at least 5 times greater than their average diameter. The fibres can be round, oval, irregularly shaped or even flat in diameter. Suitable fibres are mineral fibres or synthetic fibres, such as, in particular, glass-ceramic or particularly preferably glass fibres. The fibres are added to the monomer sol or polymerisation solution in amounts of between 1 and 50% by weight, preferably 2-30% by weight. The stabilising action can be adapted through the choice of the fibres (for example glass fibres having a length of 0.1-5 mm (preferably 0.3-3 mm) and a diameter of 1-25 μm (preferably 5-10 μm)).

If necessary for the later use, the capillaries may also be heated after application of the connecting layer. In the case of a coating comprising tetraalkoxysilanes or purely inorganic particles/fibres, calcination up to 600° C. is possible. If organoalkoxysilanes or particles/fibres having organic constituents have been employed, the temperatures should be between 100 and 300° C., unless the organic residues are to be burnt out.

It may equally be necessary, as already explained for the organic polymers, to react the connecting layer with bifunctional reagents in order that suitable functional groups are available for binding the sorbent layer.

The sorbent layer of the capillary typically has a thickness of between 1 μm and 20 μm, preferably between 2 and 10 μm.

Sorbents which are suitable in accordance with the invention are inorganic porous monolithic sorbents based on inorganic oxides, such as, for example, aluminium oxide, titanium dioxide or preferably silica, or hybrid materials. The pore structure of the sorbent layer is monomodal or preferably bimodal. Tri- or oligomodal pore distributions are also possible. At least some of the pores should have a diameter of between 3 nm and 25 μm, preferably between 5 nm and 10 μm, in order that adequate diffusion of the analytes into the sorbent and thus adequate separation is ensured. A bimodal pore distribution having large macropores (>0.1 μm, preferably >1 μm), which effect good accessibility, and mesopores between 2 and 100 nm, which effect effective separation, is particularly advantageous. Preference is given to the use of inorganic porous monolithic materials prepared by a sol-gel process. WO 95/03256 and particularly WO 98/29350 disclose processes which are preferred in accordance with the invention for the production of inorganic monolithic mouldings by a sol-gel process. These materials contain mesopores having a diameter of between 2 and 100 nm and macropores having an average diameter of greater than 0.1 μm and are thus particularly suitable for an application according to the invention.

Starting materials employed for the formation of the inorganic sorbent layer are typically silanes. Examples are disclosed in WO 95/03256 and WO 98/29350. However, a prepolymerised silane, for example polyethoxysilane, can also be employed. This is taken up, for example, in a solvent, such as ethanol, applied to the capillary wall, dried and hardened using ammonia.

Also suitable are inorganic/organic hybrid materials. These can be on the one hand organic/inorganic copolymers or silica hybrid materials in which the monomer sol comprises not only alkoxysilanes, but also typically at least 10%, preferably 20 to 100%, of organoalkoxysilanes. It has been found that the use of organoalkoxysilanes is additionally accompanied by a reduction in the shrinkage of the sorbent layer during ageing, and sorbent layers comprising organoalkoxysilanes have a lesser tendency towards cracking or flaking.

Organoalkoxysilanes are silanes in which one to three alkoxy groups, preferably one alkoxy group, of a tetraalkoxysilane has (have) been replaced by organic radicals, such as, preferably, C1 to C20 alkyl, C2 to C20 alkenyl or C5 to C20 aryl, particularly preferably C1 to C8 alkyl. Further organoalkoxysilanes are disclosed, for example, in WO 03/014450 or U.S. Pat. No. 4,017,528.

The other constituents of the monomer sol generally correspond to those of the prior art. However, it may be possible that the concentration of certain substances has to be varied slightly since organoalkoxysilanes exhibit a different polarity, reactivity or also solubility from alkoxysilanes and thus influence, for example, the phase separation or the formation of the gel body. Thus, it may be advantageous, for example, to add a water-miscible organic solvent to the monomer sol in order to compensate for these effects. Suitable solvents are, for example, ethanol or preferably methanol, where the molar ratio of water to solvent is typically between 10:1 and 1:5, preferably between 3:1 and 1:2.

It has furthermore proven advantageous for a stronger acid to be added to the monomer sol for the hydrolysis instead of the acetic acid usually used. 1M HNO₃ is particularly suitable.

In the case of the use of organoalkoxysilanes, the pore formation can furthermore be influenced in various ways, depending on what pore distribution the sorbent layer is to have.

For example, the addition of a porogen, such as, for example, polyethylene glycol, may, if desired, be omitted since organoalkoxysilanes effect the formation of macroporous structures in the moulding through the organic, non-hydrolysable radicals themselves.

If mesopores are additionally desired, a detergent can be added, for example cationic detergents, such as CTAB (CH₃(CH₂)₁₅N⁺(CH₃)₃Br⁻), nonionic detergents, such as PEG (polyethylene glycol), Brij 56 (CH₃(CH₂)₁₅—(OCH₂CH₂)₁₀—OH), Brij 58 (CH₃(CH₂)₁₅—(OCH₂CH₂)₂₀—OH) and Triton® X detergents (CH₃)₃CCH₂CH(CH₃)—C₆H₄O(CH₂CH₂O)ₓH, where x=8 (TX-114) or x=10 (TX-100), or block copolymers, such as Pluronic® P-123 (EO)₂₀(propylene oxide, PO)₇₀(EO)₂₀ or Tween® 85 (polyoxyethylene sorbitan trioleate), or alternatively an ageing process can be carried out, as disclosed, for example, in WO 95/103256 and particularly in WO 98/29350 (addition of a thermally decomposable substance, such as urea). Particles suspended in the monomer sol can likewise give rise to a mesoporous structure.

The present invention also relates to a process for the production of open tubular capillaries having a connecting layer, where the capillaries are firstly provided on the inside with at least one connecting layer, and a sorbent layer is subsequently applied.

In a preferred embodiment, the capillary is firstly activated by etching or reaction with bifunctional reagents before introduction of the connecting layer.

The connecting layer and/or sorbent layer can be applied by introducing the corresponding reaction solution into the capillary by immersion or rinsing. Various processes, such as processes for, for example, free-radical polymerisation, or also sol-gel processes, can be employed for the production of layers. The solutions which comprise the starting substances for the production of monoliths are referred to as solutions or monomer sol in accordance with the invention, irrespective of the manner in which they are polymerised or gelled.

It is possible to use solutions which correspond in composition to those for the production of monolithic mouldings, i.e. solutions which comprise relatively high concentrations of the individual reactants. If solutions of this type are used, it must be ensured that the capillary is not completely filled by the three-dimensional network formed. This can be accomplished in two ways. Firstly, the capillary can be rinsed only briefly with the solution, so that only the inside surface is wetted. The reaction solution can also be removed from the capillary by forcing out by means of a stream of gas or stream of liquid. The layer remaining in the capillary is subsequently hardened or polymerised. If necessary, the process can be repeated one or more times in order to increase the layer thickness.

Secondly, it is possible firstly to fill the capillary with the solution and to begin the hardening or polymerisation. Before the hardening is complete, the partially gelled reaction solution is forced out of the capillary by means of compressed air (or if necessary streams of inert gases) or a stream of liquid, so that a layer remains only in the wall regions, and is then fully hardened.

In both process variants, the stream of liquid employed can be an inert, preferably immiscible, liquid or a liquid comprising an additional reagent which supports the film on the capillary wall during the polymerisation and fixing or serves for aftertreatment of the layer. An example of a reagent of this type is ammonia in the case of production of the layer by a sol-gel process.

The following epitaxial growth process is preferred for the application of the sorbent layer:

Solutions of lower concentration than the solutions which are suitable for the production of monolithic mouldings are employed for this process.

Since porous monolithic mouldings (such as, for example, from WO 95/03256, WO 98/29350, WO 99/38006 or WO 99/50654) typically already have a porosity of greater than 70%, the concentration of the reactants cannot be reduced as desired. The solutions are typically employed diluted 1:2 to 1:10.

For example, in the case of the use of silanes, such as tetramethoxysilane, besides other reagents, solutions of 25 ml of silane in 75 to 200 ml of acetic acid can be employed.

The capillary is completely filled with the reaction solution by the immersion or filling, and the polymerisation or hardening is initiated. It has been found that the low concentration of reactants means that a three-dimensional network which fills the entire capillary is no longer built up. Instead, the monomers concentrate at the capillary wall, where they react with formation of a uniform layer. The epitaxial growth process according to the invention is particularly suitable for the formation of the sorbent layer since it is particularly successful if the inside wall of the capillaries has already been activated by application of a connecting layer.

When the polymerisation on the inside wall of the capillary is complete, the excess reaction solution (principally the remaining solvent) is removed, and the resultant layer is dried or if necessary aftertreated in a suitable manner for further hardening or functionalisation. If necessary, the epitaxial growth process can also be repeated one or more times.

Depending on the type of connecting layer or sorbent used, a calcination step can be carried out after the gelling and ageing of the gel, in particular in the case of sorbent layers produced by a sol-gel process. This removes all organic compounds or residues remaining in the layer. Calcination can also be carried out in the final synthesis step in the case of the use of organoalkoxysilanes in the monomer sol, so that the organic residues are removed from the layer and a completely inorganic layer is obtained. In particular in the case of the use of organoalkoxysilanes having sterically large organic radicals, this can be utilised for the production of pores. The calcination is generally carried out at temperatures between 300 and 600° C. However, it is equally possible to omit the calcination step or alternatively to select the temperature in such a way that the organic residues are not attacked. In this way, it is possible to influence the material properties of the layers, for example with respect to their chromatographic separation properties, through the organic radicals. The temperatures in this case are typically between 100 and 300° C.

In general, the capillaries are additionally provided with separation effectors for use in chromatography after the ageing or calcination. The various separation effectors and methods for their introduction are known to the person skilled in the art. Examples are given, for example, in WO 98/29350.

The capillaries according to the invention, in particular the capillaries produced by the preferred epitaxial growth process according to the invention, are distinguished by a uniform sorbent layer and good separation properties. The covalent binding in accordance with the invention of a connecting layer to the inside wall of the capillary and the sorbent layer covalently bonded to the connecting layer and the preferred embodiments indicated enable cracking and lump formation to be avoided.

The type of connecting layer and sorbent layer that should be combined depends on the material of the capillary and the planned application of the capillary.

Even without further comments, it is assumed that a person skilled in the art will be able to utilise the above description in the broadest scope. The preferred embodiments and examples should therefore merely be regarded as descriptive disclosure which is absolutely not limiting in any way.

The complete disclosure content of all applications, patents and publications mentioned above and below, in particular the corresponding application EP 04 013 549, filed on Sep. 6, 2004, is incorporated into this application by way of reference.

### EXAMPLES

For the following examples, capillaries (fused silica) having an internal diameter of 50 or 100 μm and an external diameter of about 360 μm are used.

1. Pretreatment of the Capillary

Activation (cleaning) of the surface, for example by washing with a solvent (ethanol or heptane) or by treatment with 1N NaOH (rinsing with water) and 1N HCl at 40° C. for 2 (subsequently again rinsing with water).

2. Covering with a Connecting Layer

A Connecting Layer Comprising SiO₂

2.08 g (0.01 mol) of tetraethoxysilane (TES) are mixed with ethanol in a ratio of 1:10. 0.06 mol of NH₃ is added to the mixture, which is stirred until a homogeneous mixture is formed. The mixture is pumped into the capillary and stored at 60° C. for 5 hours. The solution in the capillary is exchanged with a water/ethanol 1:1 mixture and subsequently with water. An SiO₂ layer with a thickness of approx. 1-5 μm has formed. Drying for 4 h at 80° C. under reduced pressure.

B Connecting Layer Comprising Hybrid Materials

a)

0.06 mol of TES (=12.5 g) are mixed with 0.02 mol of methyltrimethoxysilane (MTMS) (=2.7 g) in 50 ml of ethanol/water 1:1, and 0.03 mol of ammonia is added. After the mixture has homogenised by stirring (room temperature), the homogeneous mixture is sprayed into the capillary and left in the capillary at 40° C. for 10 hours. The solution in the capillary is exchanged with a water/ethanol 1:1 mixture and subsequently with water. A hybrid SiO₂ layer with a thickness of approx. 1-3 μm has formed. Drying for 4 h at 80° C. under reduced pressure.

b)

0.02 mol of methyltrimethoxysilane (MTMS)=2.7 g is mixed with 10 ml of ethanol/water 1:1, and 0.5 g of 1M HNO₃ is added. After the mixture has homogenised by stirring (room temperature), the homogeneous mixture is sprayed into the capillary and left in the capillary at 40° C. for 10 hours. The solution in the capillary is exchanged with a water/ethanol 1:1 mixture and subsequently with water. An MTMS layer with a thickness of approx. 1-3 μm has formed. Drying for 4 h at 80° C. under reduced pressure.

C Connecting Layer Comprising a Polymer

A capillary having an internal diameter of 100 μm is filled with a mixture of 5% of methacryloxypropyltrimethoxysilane in ethanol and left to stand overnight at room temperature. The solution in the capillary is exchanged with ethanol and subsequently dried using nitrogen and at 60° C. (12 hours) in a drying cabinet. A styrene:divinylbenzene 0.1 mol:0.1 mol mixture and 50 mg of AIBN (free-radical initiator) in 10 ml of ethanol are sprayed into the pretreated capillary. After approx. 10 minutes, the reaction solution is forced out by means of a weak stream of nitrogen, and the capillary is immediately placed in an oven at 80° C. After the capillary has been washed out with ethanol, a polymer layer with a thickness of approx. 1-3 μm has formed. Drying for 4 h at 80° C. under reduced pressure.

3. Formation of the Sorbent Layer

A solution of 2.5 ml of tetramethoxysilane, 1.02 g of polyethylene oxide (molecular weight 10,000-35,000 g/mol) and 0.9 g of urea in 10 ml of 0.01N acetic acid is introduced into a capillary provided with connecting layer and left in the capillary at 40° C. for at least 10 hours. The solution in the capillary is exchanged with a water/ethanol 1:1 mixture and subsequently with water. A porous SiO₂ layer with a thickness of approx. 3-10 μm has formed. Drying for 4 h at 80° C. under reduced pressure. Careful calcination at 300° C. stabilises the layer.

1. Open tubular capillary, characterised in that at least one connecting layer consisting of one of the following materials is located between the inside wall of the capillary and the sorbent:
bifunctional reagents
inorganic polymers
inorganic/organic hybrid materials
organic polymers

2. Open tubular capillary according to claim 1, characterised in that the connecting layer has a thickness of 1 to 5 μm.

3. Open tubular capillary according to claim 1, characterised in that the capillary has an internal diameter of between 20 μm and 1 mm.

4. Open tubular capillary according to claim 1, characterised in that the capillary is a fused silica capillary.

5. Open tubular capillary according to claim 1, characterised in that the inside wall of the capillary is completely covered by the connecting layer.

6. Open tubular capillary according to claim 1, characterised in that the connecting layer comprises fibres or particles.

7. Process for the production of open tubular capillaries, in which a connecting layer is located between the inside wall of the capillary and the sorbent, characterised by the following process steps:
a) provision of a capillary
b) application of at least one connecting layer consisting of one of the following materials:
bifunctional reagents
inorganic polymers
inorganic/organic hybrid materials
organic polymers
c) application of the sorbent layer.

8. Process according to claim 7, characterised in that the inside wall of the capillary is activated in a step aa) before application of the connecting layer by treatment with strong acids, strong bases or other etchants,

9. Process according to claim 7, characterised in that a sol-gel process is used for the production of the sorbent layer.

10. Process according to claim 7, characterised in that the sorbent layer is applied by introduction of a dilute polymerisation solution.

11. Open tubular capillary columns produced by the process corresponding to claim 7.

12. Use of the capillary columns according to claim 1 in liquid chromatography.
